(19) United States
(12) Patent Application Publication
(10) Pub. No.: US 2008/0086700 A1
(43) Pub. Date: Apr. 10, 2008

(54) Systems and Methods for Isolating On-Screen Textual Data

(76) Inventors: Robert A. Rodriguez, San Jose, CA (US); Eric Brueggemann, San Jose, CA (US)

Correspondence Address: CHOATE, HALL & STEWART / CITRIX SYSTEMS, INC., TWO INTERNATIONAL PLACE, BOSTON, MA, 02110, US

(21) Appl. No.: 11/539,515

(22) Filed: Oct. 6, 2006

(51) Int. Cl. G06F 3/048

(52) U.S. Cl. 715/804; 715/808

(57) ABSTRACT

The systems and methods of the client agent describe herein provides a solution to obtaining, recognizing and taking an action on text displayed by an application that is performed in a non-intrusive and application agnostic manner. In response to detecting idle activity of a cursor on the screen, the client agent captures a portion of the screen relative to the position of the cursor. The portion of the screen may include a textual element having text, such as a telephone number or other contact information. The client agent calculates a desired or predetermined scanning area based on the default fonts and screen resolution as well as the cursor position. The client agent performs optical character recognition on the captured image to determine any recognized text. By performing pattern matching on the recognized text, the client agent determines if the text has a format or content matching a desired pattern, such as phone number. In response to determining the recognized text corresponds to a desired pattern, the client agent displays a user interface element on the screen near the recognized text. The user interface element may be displayed as an overlay or superimposed to the textual element such that it seamlessly appears integrated with the application. The user interface element is selectable to take an action associated with the recognized text.

### FIELD OF THE INVENTION

The present invention generally relates to voice over internet protocol data communication networks. In particular, the present invention relates to systems and methods for detecting contact information from on screen textual data and providing a user interface element to initiate a telecommunication session based on the contact information.

### BACKGROUND OF THE INVENTION

Typically, applications, such as applications running on a Microsoft Windows operating system, do not allow for acquisition of textual data it displays on the screen for utilization by a third-party application. For example, an application running on a desktop may display on the screen information such as an email address or a telephone number. This information may be of interest to other applications. However, this information may not be in a form easily obtained by the third-party application as it is embedded in the application. For example, the application may display this textual information via source code, or a programming component, such as an Active X control or Java script.

Without specific integration to the desktop application, the third-party application would not know an email address or telephone number is being displayed on the screen. Furthermore, in some cases, the third-party application would need to have foreknowledge of the application and a specifically designed interface to the application and in order to obtain such screen data. In the case of many applications, the third-party application would have to design specific interfaces to support each application in order to obtain and act on textual screen data of interest. Besides the need for being application aware, this approach would be intrusive to the application and costly to implement, maintain and support for each application.

It would, therefore, be desirable to provide systems and methods for obtaining textual on-screen data displayed by an application in a non-intrusive and application agnostic manner.

### BRIEF SUMMARY OF THE INVENTION

The systems and methods of the client agent describe herein provides a solution to obtaining, recognizing and taking an action on text displayed by an application that is performed in a non-intrusive and application agnostic manner. In response to detecting idle activity of a cursor on the screen, the client agent captures a portion of the screen relative to the position of the cursor. The portion of the screen may include a textual element having text, such as a telephone number or other contact information. The client agent calculates a desired or predetermined scanning area based on the default fonts and screen resolution as well as the cursor position. The client agent performs optical character recognition on the captured image to determine any recognized text. By performing pattern matching on the recognized text, the client agent determines if the text has a format or content matching a desired pattern, such as phone number. In response to determining the recognized text corresponds to a desired pattern, the client agent displays a user interface element on the screen near the recognized text. The user interface element may be displayed as an overlay or superimposed to the textual element such that it seamlessly appears integrated with the application. The user interface element is selectable to take an action associated with the recognized text.

The techniques of the client agent described herein are useful for providing a “click-2-call” solution for any applications running on the client that may display contact information. The client agent runs transparently to any application of the client and obtains via screen capturing and optical character recognition contact information displayed by the application. In response to recognizing the contact information displayed on the screen, the client agent provides a user interface element selectable to initiate and establish a telecommunication session, such as using Voice over Internet Protocol of a soft phone or Internet Protocol phone of the client. Instead of manually entering the contact information through an interface of the soft phone or IP phone, the user can select the user interface element provided by the client agent to automatically and easily make the telecommunication call. The techniques of the client agent are applicable to automatically initiating any type and form of telecommunications including video, email, instant messaging, short message service, faxing, mobile phone calls, etc from textual information embedded in applications.

In one aspect, the present invention is related to a method of determining a user interface is displaying a textual element identifying contact information and automatically providing in response to the determination a selectable user interface element near the textual element to initiate a telecommunication session based on the contact information. The includes capturing, by a client agent, an image of a portion of a screen of a client, and recognizing, by the client agent, via optical character recognition text of the textual element in the captured image. The portion of the screen may display a textual element identifying contact information. The method also includes determining, by the client agent, the recognized text comprises contact information, and displaying, by the client agent in response to the determination, a user interface element near the textual element on the screen selectable to initiate a telecommunication session based on the contact information. In some embodiments, the client agent performs this method in 1 second or less.

In some embodiments, the method includes capturing, by the client agent, the image in response to detecting the cursor on the screen is idle for a predetermined length of time. In one embodiment, the predetermined length of time is between 400 ms and 600 ms, such as approximately 500 ms. In some embodiments, the client agent captures the image of the portion of the screen as a bitmap. The method also includes identifying, by the client agent, the portion of the screen as a rectangle calculated based on one or more of the following: 1) default font pitch, 2) screen resolution width, 3) screen resolution height, 4) x-coordinate of the position of the cursor and y-coordinate of the position of the cursor. In some embodiments, the client agent captures the image of the portion of the screen relative to a position of a cursor.

In some embodiments, the method includes displaying, by the client agent, a window near the cursor or textual element on the screen, The window may have a selectable user interface element, such as a menu item, to initiate the telecommunication session. In another embodiment, the method includes displaying, by the client agent, the user interface element as a selectable icon. In some cases, the client agent displays the selectable user interface element superimposed over or as an overlay of the portion of the screen. In yet another embodiment, the method includes displaying, by the client agent, the selectable user interface element while the cursor is idle.

In some embodiments of the method of the present invention, the contact information identifies a name of a person, a company or a telephone number. In one embodiment, a user selects the selectable user interface element provided by the client agent to initiate the telecommunication session. In some embodiments, the client agent transmits information to a gateway device to establish the telecommunication session on behalf of the client. In another embodiment, the gateway device initiates or establishes the telecommunications session via a telephony application programming interface. In a further embodiment, the client agent establishes the telecommunications session via a telephony application programming interface.

In another aspect, the present invention is related to a system for determining a user interface is displaying a textual element identifying contact information and automatically providing in response to the determination a selectable user interface element near the textual element to initiate a telecommunication session based on the contact information. The system includes a client agent executing on a client. The client agent includes a cursor activity detector to detect activity of a cursor on a screen. The client agent also includes a screen capture mechanism to capture, in response to the cursor activity detector, an image of a portion of the screen displaying a textual element identifying contact information. The client agent has an optical character recognizer to recognize text of the textual element in the captured image. A pattern matching engine of the client agent determines the recognized text includes contact information, such as a phone number. In response to the determination the client agent displays a user interface element near the textual element on the screen selectable to initiate a telecommunication session based on the contact information.

In some embodiments, the screen capture mechanism captures the image in response to detecting the cursor on the screen is idle for a predetermined length of time. The predetermined length of time may be between 400 ms and 600 ms, such as 500 ms. In one embodiment, the client agent displays a window near the cursor or textual element on the screen. The window may provide a selectable user interface element to initiate the telecommunication session. In one embodiment, the client agent displays the selectable user interface element superimposed over the portion of the screen. In another embodiment, the client agent displays the user interface element as a selectable icon. In some cases, the client agent displays the selectable user interface element while the cursor is idle.

In one embodiment, the screen capturing mechanism captures the image of the portion of the screen as a bitmap. In some embodiments, the contact information of the textual element a name of a person, a company or a telephone number. In another embodiment, a user of the client selects the selectable user interface element to initiate the telecommunication session. In one case, the client agent transmits information to a gateway device to establish the telecommunication session on behalf of the client. In some embodiments, the gateway device establishes the telecommunications session via a telephony application programming interface. In another embodiment, the client agent establishes the telecommunications session via a telephony application programming interface.

In some embodiments, the client agent identifies the portion of the screen as a rectangle determined or calculated based on one or more of the following: 1) default font pitch, 2) screen resolution width, 3) screen resolution height, 4) x-coordinate of the position of the cursor and 5) y-coordinate of the position of the cursor. In one embodiment, the screen capturing mechanism captures the image of the portion of the screen relative to a position of a cursor.

In yet another aspect, the present invention is related to a method of automatically recognizing text of a textual element displayed by an application on a screen of a client and in response to the recognition displaying a selectable user interface element to take an action based on the text. The method includes detecting, by a client agent, a cursor on a screen of a client is idle for a predetermined length of time, and capturing, in response to the detection, an image of a portion of a screen of a client, the portion of the screen displaying a textual element. The method also includes recognizing, by the client agent, via optical character recognition text of the textual element in the captured image, and determining the recognized text corresponds to a predetermined pattern. In response to the determination, the method includes displaying, by the client agent, near the textual element on the screen a selectable user interface element to take an action based on the recognized text.

In one embodiment, the predetermined length of time is between 400 ms and 600 ms. In another embodiment, the method includes displaying, by the client agent, a window near the cursor or textual element on the screen. The window may provide the selectable user interface element, such as a menu item, to initiate the telecommunication session. In another embodiment of the method, the client agent displays the selectable user interface element superimposed over the portion of the screen. In one embodiment, the client agent displays the user interface element as a selectable icon. In some cases, the client agent displays the selectable user interface element while the cursor is idle.

In one embodiment, the method includes capturing, by the client agent, the image of the portion of the screen as a bitmap. In some embodiments, the method includes determining, by the client agent, the recognized text corresponds to a predetermined pattern of a name of a person or company or a telephone number. In other embodiments, the method includes selecting, by a user of the client, the selectable user interface element to take the action based on the recognized text. In one embodiment, the action includes initiating a telecommunication session or querying contacting information based on the recognized text.

In some embodiments, the method includes identifying, by the client agent, the portion of the screen as a rectangle calculated based on one or more of the following: 1) default font pitch, 2) screen resolution width, 3) screen resolution height, 4) x-coordinate of the position of the cursor and 5) y-coordinate of the position of the cursor. In another embodiment, the client agent captures the image of the portion of the screen relative to a position of a cursor.

The details of various embodiments of the invention are set forth in the accompanying drawings and the description below.

### BRIEF DESCRIPTION OF THE FIGURES

The foregoing and other objects, aspects, features, and advantages of the invention will become more apparent and better understood by referring to the following description taken in conjunction with the accompanying drawings, in which:

FIG. 1A is a block diagram of an embodiment of a network environment for a client to access a server via an appliance;

FIG. 1B is a block diagram of an embodiment of an environment for providing media over internet protocol communications via a gateway;

FIGS. 1C and 1D are block diagrams of embodiments of a computing device;

FIG. 2A is a block diagram of an embodiment of a client agent for capturing and recognizing portions of a screen to determine to display a selectable user interface for taking an action associated with text from a textual element of the screen;

FIG. 2B is a block diagram of an embodiment of the client agent for determining the portion of the screen to capture as an image;

FIG. 2C is a block diagram of an embodiment of the client agent displaying a user interface element for taking an action based on recognized text; and

FIG. 3 is a flow diagram of steps of an embodiment of a method for practicing a technique of recognizing text of on screen textual data captured as an image and displaying a selectable user interface for taking an action associated with the recognized text.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION OF THE INVENTION

### A. Network and Computing Environment

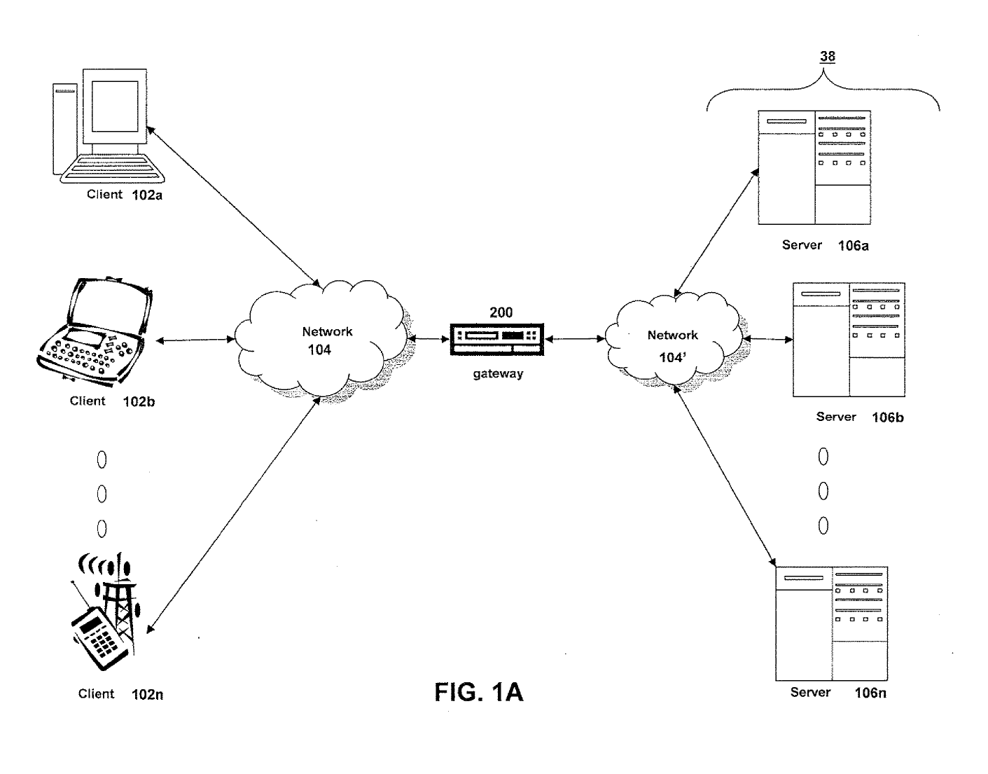

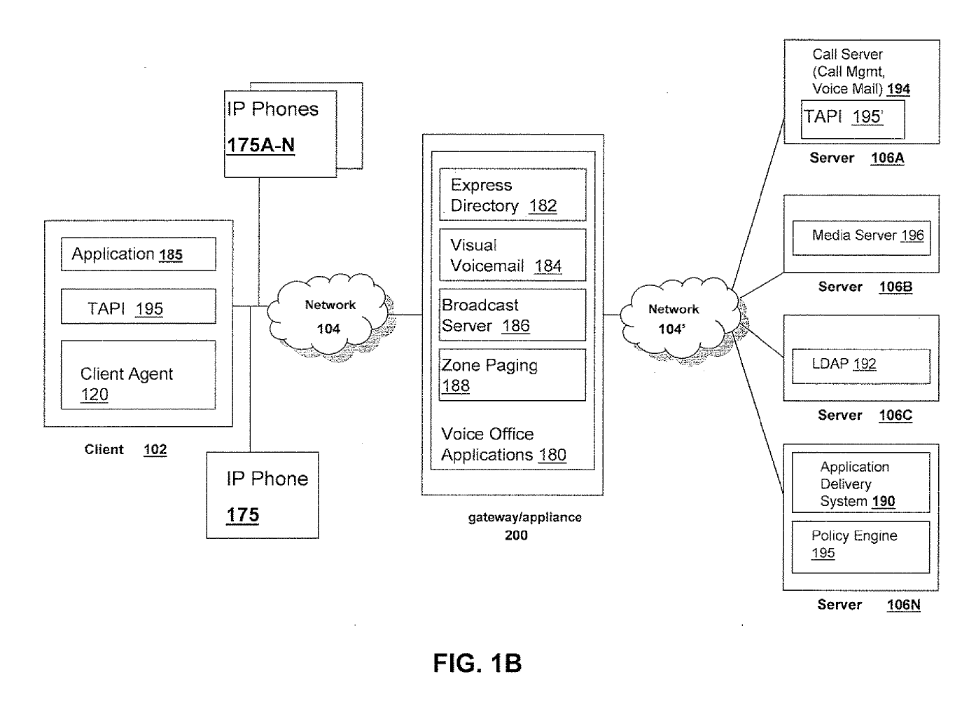

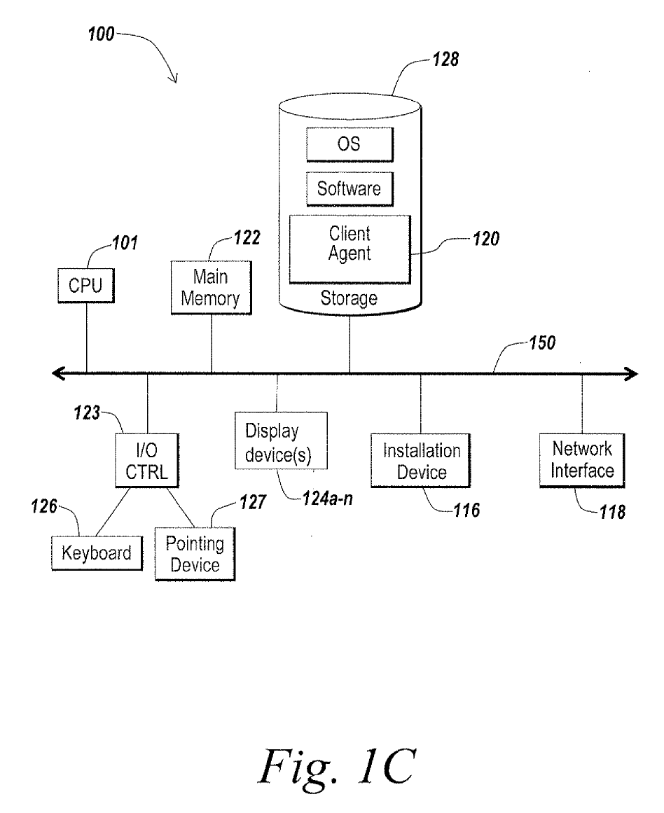

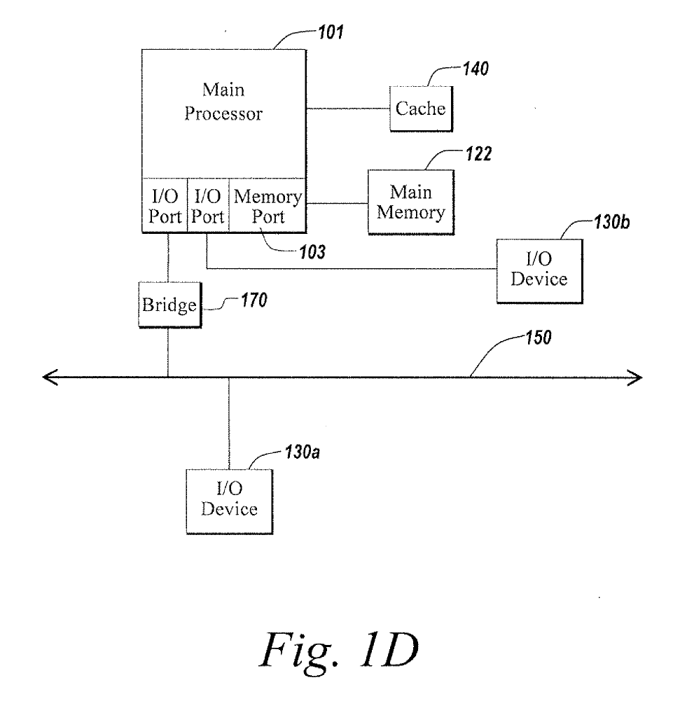

Prior to discussing the specifics of embodiments of the systems and methods describe herein, it may be helpful to discuss the network and computing environments in which such embodiments may be deployed. Referring now to FIG. 1A, an embodiment of a network environment is depicted. In brief overview, the network environment comprises one or more clients 102a-102n (also generally referred to as local machine(s) 102, or client(s) 102) in communication with one or more servers 106a-106n (also generally referred to as server(s) 106, or remote machine(s) 106) via one or more networks 104, 104′ (generally referred to as network 104). In some embodiments, a client 102 communicates with a server 106 via a gateway device or appliance 200.

Although FIG. 1A shows a network 104 and a network 104′ between the clients 102 and the servers 106, the clients 102 and the servers 106 may be on the same network 104. The networks 104 and 104′ can be the same type of network or different types of networks. The network 104 and/or the network 104′ can be a local-area network (LAN), such as a company Intranet, a metropolitan area network (MAN), or a wide area network (WAN), such as the Internet or the World Wide Web. In one embodiment, network 104′ may be a private network and network 104 may be a public network. In some embodiments, network 104 may be a private network and network 104′ a public network. In another embodiment, networks 104 and 104′ may both be private networks. In some embodiments, clients 102 may be located at a branch office of a corporate enterprise communicating via a WAN connection over the network 104 to the servers 106 located at a corporate data center.

The network 104 and/or 104′ be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 104 may comprise a wireless link, such as an infrared channel or satellite band. The topology of the network 104 and/or 104′ may be a bus, star, or ring network topology. The network 104 and/or 104′ and network topology may be of any such network or network topology as known to those ordinarily skilled in the art capable of supporting the operations described herein.

As shown in FIG. 1A, the gateway 200, which also may be referred to as an interface unit 200 or appliance 200, is shown between the networks 104 and 104′. In some embodiments, the appliance 200 may be located on network 104. For example, a branch office of a corporate enterprise may deploy an appliance 200 at the branch office. In other embodiments, the appliance 200 may be located on network 104′. For example, an appliance 200 may be located at a corporate data center. In yet another embodiment, a plurality of appliances 200 may be deployed on network 104. In some embodiments, a plurality of appliances 200 may be deployed on network 104′. In one embodiment, a first appliance 200 communicates with a second appliance 200′. In other embodiments, the appliance 200 could be a part of any client 102 or server 106 on the same or different network 104,104′ as the client 102. One or more appliances 200 may be located at any point in the network or network communications path between a client 102 and a server 106.

In one embodiment, the system may include multiple, logically-grouped servers 106. In these embodiments, the logical group of servers may be referred to as a server farm 38. In some of these embodiments, the serves 106 may be geographically dispersed. In some cases, a farm 38 may be administered as a single entity. In other embodiments, the server farm 38 comprises a plurality of server farms 38. In one embodiment, the server farm executes one or more applications on behalf of one or more clients 102.

The servers 106 within each farm 38 can be heterogeneous. One or more of the servers 106 can operate according to one type of operating system platform (e.g., WINDOWS NT, manufactured by Microsoft Corp. of Redmond, Wash.), while one or more of the other servers 106 can operate on according to another type of operating system platform (e.g., Unix or Linux). The servers 106 of each farm 38 do not need to be physically proximate to another server 106 in the same farm 38. Thus, the group of servers 106 logically grouped as a farm 38 may be interconnected using a wide-area network (WAN) connection or medium-area network (MAN) connection. For example, a farm 38 may include servers 106 physically located in different continents or different regions of a continent, country, state, city, campus, or room. Data transmission speeds between servers 106 in the farm 38 can be increased if the servers 106 are connected using a local-area network (LAN) connection or some form of direct connection.

Servers 106 may be referred to as a file server, application server, web server, proxy server, or gateway server. In some embodiments, a server 106 may have the capacity to function as either an application server or as a master application server. In one embodiment, a server 106 may include an Active Directory. The clients 102 may also be referred to as client nodes or endpoints. In some embodiments, a client 102 has the capacity to function as both a client node seeking access to applications on a server and as an application server providing access to hosted applications for other clients 102a-102n.

In some embodiments, a client 102 communicates with a server 106. In one embodiment, the client 102 communicates directly with one of the servers 106 in a farm 38. In another embodiment, the client 102 executes a program neighborhood application to communicate with a server 106 in a farm 38. In still another embodiment, the server 106 provides the functionality of a master node. In some embodiments, the client 102 communicates with the server 106 in the farm 38 through a network 104. Over the network 104, the client 102 can, for example, request execution of various applications hosted by the servers 106a-106n in the farm 38 and receive output of the results of the application execution for display. In some embodiments, only the master node provides the functionality required to identify and provide address information associated with a server 106′ hosting a requested application.

In one embodiment, the server 106 provides functionality of a web server. In another embodiment, the server 106a receives requests from the client 102, forwards the requests to a second server 106b and responds to the request by the client 102 with a response to the request from the server 106b. In still another embodiment, the server 106 acquires an enumeration of applications available to the client 102 and address information associated with a server 106 hosting an application identified by the enumeration of applications. In yet another embodiment, the server 106 presents the response to the request to the client 102 using a web interface. In one embodiment, the client 102 communicates directly with the server 106 to access the identified application. In another embodiment, the client 102 receives application output data, such as display data, generated by an execution of the identified application on the server 106.

Referring now to FIG. 1B, a network environment for delivering voice and data applications, such as voice over internet protocol (VoIP) or IP telephone application on a client 102 or IP Phone 175 is depicted. In brief overview, a client 10 is in communication with a server 106 via network 104, 104′ and appliance 200. For example, the client 102 may reside in a remote office of a company, e.g., a branch office, and the server 106 may reside at a corporate data center. The client 102 or a user of the client may access an IP Phone 175 to communicate via an IP based telecommunication session via network 104. The client 102 includes a client agent 120, which may be used to facilitate the establishment of a telecommunication session via the IP Phone 175. In some embodiments, the client 102 includes any type and form of telephony application programming interface (TAPI) 195 to communicate with, interface to and/or program an IP phone 175.

The IP Phone 175 may comprise any type and form of telecommunication device for communicating via a network 104. In some embodiments, the IP Phone 175 may comprise a VoIP device for communicating voice data over internet protocol communications. For example, in one embodiment, the IP Phone 175 may include any of the family of Cisco IP Phones manufactured by Cisco Systems, Inc. of San Jose, Calif. In another embodiment, the IP Phone 175 may include any of the family of Nortel IP Phones manufactured by Nortel Networks, Limited of Ontario, Canada. In other embodiments, the IP Phone 175 may include any of the family of Avaya IP Phones manufactured by Avaya, Inc. of Basking Ridge, N.J. The IP Phone 175 may support any type and form of protocol, including any real-time data protocol, Session Initiation Protocol (SIP), or any protocol related to IP telephony signaling or the transmission of media, such as voice, audio or data via a network 104. The IP Phone 175 may include any type and form of user interface in the support of delivering media, such as video, audio and data, and/or applications to the user of the IP Phone 175.

In one embodiment, the gateway 200 provides or supports the provision of IP telephony services and applications to the client 102, IP Phone 175, and/or client agent 102. In some embodiment, the gateway 200 includes Voice Office Applications 180 having a set of one or more telephony applications. In one embodiment, the Voice Office Applications 180 comprises the Citrix Voice Office Application suite of telephony applications manufactured by Citrix Systems, Inc of Ft. Lauderdale, Fla. By way of example, the Voice Office Applications 180 may include Express Directory application 182, a visual voicemail application 184, a broadcast server 186 application and/or a zone paging application 188. Any of these applications 182, 184, 186 and 188, alone or in combination, may execute on the appliance 200, or on a server 106A-106N. The appliance 200 and/or Voice Office Applications 180 may transcode, transform or otherwise process user interface content to display in the form factor of the display of the IP Phone 175.

The express directory application 182 provides a Lightweight Directory Access Protocol (LDAP)-based organization-wide directory. In some embodiments, the appliance 200 may communicate with or have access to one more LDAP services, such as the server 106C depicted in FIG. 1B. The appliance 200 may support any type and form of LDAP protocol. In one embodiment, the express directory application 182 provides users of the IP phone 175 with access to LDAP directories. In another embodiment, the express directory application 182 provides users of the IP Phone 175 with access to directories or directory information saves in a comma-separated value (CSV) format. In some embodiments, the express directory application 182 obtains directory information from one or more LDAP directories and CSV directory files. In some embodiments, the appliance 200, voice office application 180 and/or express directory application 182 transcodes directory information for display on the IP Phone 175. In one embodiment, the appliance 200 supports LDAP directories 192 provided by Microsoft Active Directory manufactured by the Microsoft Corporation of Redmond, Wash. In another embodiment, the appliance 200 supports an LDAP directory provided via OpenLDAP, which is an open source implementation of LDAP found at www.openldap.org. In some embodiments, the appliance 200 supports an LDAP directory provided by SunONE/iPlanet LDAP manufactured by Sun Microsystems, Inc. of Santa Clara, Calif.

The visual voicemail application 184 allows users to see and manage via the IP Phone 175 or the client 102 a visual list of the voice mail messages with the ability to select voice mail messages to review in a non-subsequent manner. The visual voicemail application 184 also provides the user with the capability to play, pause, rewind, reply to, forward etc. using labeled soft keys on the IP phone 175 or client 102. In one embodiment, as depicted in FIG. 1B, the appliance 200 and/or visual voicemail application 184 may communicate with and/or interface to any type and form of call management server 194. In some embodiments, the call server 194 may include any type and form of voicemail provisioning and/or management system, such as Cisco Unity Voice Mail or Cisco Unified CallManager manufactured by Cisco Systems, Inc. of San Jose, Calif. In other embodiments, the call server 194 may include Communication Manager manufactured by Avaya Inc. of Basking Ridge, N.J. In yet another embodiment, the call server 194 may include any of the Communication Servers manufactured by Nortel Networks Limited of Ontario, Canada. The call server 194 may comprise a telephony application programming interface (TAPI) 195 to communicate with any type and form of IP Phone 175.

The broadcast server application 186 delivers prioritized messaging, such as emergency, information technology or weather alerts in the form of text and/or audio messages to IP Phones 175 and/or clients 102. The broadcast server 186 provides an interface for creating and scheduling alert delivery. The appliance 200 manages alerts and transforms then for delivery to the IP Phones 175A-175N. Using a user interface, such as web-based interface, a user via the broadcast server 186 can create alerts to target for delivery to a group of phones 175A-175N. In one embodiment, the broadcast server 186 executes on the appliance 200. In another embodiment, the broadcast server 186 runs on a server, such as any of the servers 106A-106N. In some embodiments, the appliance 200 provides the broadcast server 184 with directory information and handles communications with the IP phones 175 and any other servers, such as LDAP 192 or a media server 196.

The zone paging application 188 enables a user to page groups of IP Phones 175 in specific zones. In one embodiment, the appliance 200 can incorporate, integrate or otherwise obtain paging zones from a directory server, such as LDAP or CSV files 192. In some embodiments, the zone paging application 188 pages IP Phones 175A-17N in the same zone. In another embodiment, IP Phones 175 or extensions thereof are specified to have zone paging permissions. In one embodiment, the appliance 200 and/or zone paging application 188 synchronizes with the call server 194 to update mapping of extensions of IP phones 175 with internet protocol addresses. In some embodiments, the appliance 200 and/or zone paging application 188 obtains information from the call server 194 to provide a DN/IP (internet protocol) map. A DN is name that uniquely defines a directory entry within an LDAP database 192 and locates it within the directory tree. In some cases, a DN is similar to a fully-qualified file name in a file system. In one embodiment, the DN is a directory number. In other embodiments, a DN is a distinguished name or number for an entry in LDAP or for a IP phone extension 175 or user of the IP phone 175.

In some embodiments, the appliance 200 acts as a proxy or access server to provide access to the one or more servers 106. In one embodiment, the appliance 200 provides and manages access to one or media server 196. A media server 196 may serve, manage or otherwise provide any type and form of media content, such as video, audio, data or any combination thereof. In another embodiment, the appliance 200 provides a secure virtual private network connection from a first network 104 of the client 102 to the second network 104′ of the server 106, such as an SSL VPN connection. It yet other embodiments, the appliance 200 provides application firewall security, control and management of the connection and communications between a client 102 and a server 106.

In one embodiment, a server 106 includes an application delivery system 190 for delivering a computing environment or an application and/or data file to one or more clients 102. In some embodiments, the application delivery management system 190 provides application delivery techniques to deliver a computing environment to a desktop of a user, remote or otherwise, based on a plurality of execution methods and based on any authentication and authorization policies applied via a policy engine. With these techniques, a remote user may obtain a computing environment and access to server stored applications and data files from any network connected device 100. In one embodiment, the application delivery system 190 may reside or execute on a server 106. In another embodiment, the application delivery system 190 may reside or execute on a plurality of servers 106a-106n. In some embodiments, the application delivery system 190 may execute in a server farm 38. In one embodiment, the server 106 executing the application delivery system 190 may also store or provide the application and data file. In another embodiment, a first set of one or more servers 106 may execute the application delivery system 190, and a different server 106n may store or provide the application and data file. In some embodiments, each of the application delivery system 190, the application, and data file may reside or be located on different servers. In yet another embodiment, any portion of the application delivery system 190 may reside, execute or be stored on or distributed to the appliance 200, or a plurality of appliances.

The client 102 may include a computing environment for executing an application that uses or processes a data file. The client 102 via networks 104, 104′ and appliance 200 may request an application and data file from the server 106. In one embodiment, the appliance 200 may forward a request from the client 102 to the server 106. For example, the client 102 may not have the application and data file stored or accessible locally. In response to the request, the application delivery system 190 and/or server 106 may deliver the application and data file to the client 102. For example, in one embodiment, the server 106 may transmit the application as an application stream to operate in computing environment 15 on client 102.

In some embodiments, the application delivery system 190 comprises any portion of the Citrix Access Suite™ by Citrix Systems, Inc., such as the MetaFrame or Citrix Presentation Server™ and/or any of the Microsoft® Windows Terminal Services manufactured by the Microsoft Corporation. In one embodiment, the application delivery system 190 may deliver one or more applications to clients 102 or users via a remote-display protocol or otherwise via remote-based or server-based computing. In another embodiment, the application delivery system 190 may deliver one or more applications to clients or users via streaming of the application.

In one embodiment, the application delivery system 190 includes a policy engine 195 for controlling and managing the access to, selection of application execution methods and the delivery of applications. In some embodiments, the policy engine 195 determines the one or more applications a user or client 102 may access. In another embodiment, the policy engine 195 determines how the application should be delivered to the user or client 102, e.g., the method of execution. In some embodiments, the application delivery system 190 provides a plurality of delivery techniques from which to select a method of application execution, such as a server-based computing, streaming or delivering the application locally to the client 120 for local execution.

In one embodiment, a client 102 requests execution of an application program and the application delivery system 190 comprising a server 106 selects a method of executing the application program. In some embodiments, the server 106 receives credentials from the client 102. In another embodiment, the server 106 receives a request for an enumeration of available applications from the client 102. In one embodiment, in response to the request or receipt of credentials, the application delivery system 190 enumerates a plurality of application programs available to the client 102. The application delivery system 190 receives a request to execute an enumerated application. The application delivery system 190 selects one of a predetermined number of methods for executing the enumerated application, for example, responsive to a policy of a policy engine. The application delivery system 190 may select a method of execution of the application enabling the client 102 to receive application-output data generated by execution of the application program on a server 106. The application delivery system 190 may select a method of execution of the application enabling the local machine 10 to execute the application program locally after retrieving a plurality of application files comprising the application. In yet another embodiment, the application delivery system 190 may select a method of execution of the application to stream the application via the network 104 to the client 102.

A client 102 may execute, operate or otherwise provide an application 185, which can be any type and/or form of software, program, or executable instructions such as any type and/or form of web browser, web-based client, client-server application, a thin-client computing client, an ActiveX control, or a Java applet, or any other type and/or form of executable instructions capable of executing on client 102. In some embodiments, the application 185 may be a server-based or a remote-based application executed on behalf of the client 102 on a server 106. In one embodiment the server 106 may display output to the client 102 using any thin-client or remote-display protocol, such as the Independent Computing Architecture (ICA) protocol manufactured by Citrix Systems, Inc. of Ft. Lauderdale, Fla. or the Remote Desktop Protocol (RDP) manufactured by the Microsoft Corporation of Redmond, Wash. The application 185 can use any type of protocol and it can be, for example, an HTTP client, an FTP client, an Oscar client, or a Telnet client. In other embodiments, the application 185 comprises any type of software related to VoIP communications, such as a soft IP telephone. In further embodiments, the application 185 comprises any application related to real-time data communications, such as applications for streaming video and/or audio.

In some embodiments, the server 106 or a server farm 38 may be running one or more applications, such as an application providing a thin-client computing or remote display presentation application. In one embodiment, the server 106 or server farm 38 executes as an application, any portion of the Citrix Access Suite™ by Citrix Systems, Inc., such as the MetaFrame or Citrix Presentation Server™, and/or any of the Microsoft® Windows Terminal Services manufactured by the Microsoft Corporation. In one embodiment, the application is an ICA client, developed by Citrix Systems, Inc. of Fort Lauderdale, Fla. In other embodiments, the application includes a Remote Desktop (RDP) client, developed by Microsoft Corporation of Redmond, Wash. Also, the server 106 may run an application, which for example, may be an application server providing email services such as Microsoft Exchange manufactured by the Microsoft Corporation of Redmond, Wash., a web or Internet server, or a desktop sharing server, or a collaboration server. In some embodiments, any of the applications may comprise any type of hosted service or products, such as GoToMeeting™ provided by Citrix Online Division, Inc. of Santa Barbara, Calif., WebEx™ provided by WebEx, Inc. of Santa Clara, Calif., or Microsoft Office Live Meeting provided by Microsoft Corporation of Redmond, Wash.

The client 102, server 106, and appliance 200 may be deployed as and/or executed on any type and form of computing device, such as a computer, network device or appliance capable of communicating on any type and form of network and performing the operations described herein. FIGS. 1C and 1D depict block diagrams of a computing device 100 useful for practicing an embodiment of the client 102, server 106 or appliance 200. As shown in FIGS. 1C and 1D, each computing device 100 includes a central processing unit 101, and a main memory unit 122. As shown in FIG. 1C, a computing device 100 may include a visual display device 124, a keyboard 126 and/or a pointing device 127, such as a mouse. Each computing device 100 may also include additional optional elements, such as one or more input/output devices 130a-130b (generally referred to using reference numeral 130), and a cache memory 140 in communication with the central processing unit 101.

The central processing unit 101 is any logic circuitry that responds to and processes instructions fetched from the main memory unit 122. In many embodiments, the central processing unit is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 101, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 122 may be based on any of the above described memory chips, or any other available memory chips capable of operating as described herein. In the embodiment shown in FIG. 1C, the processor 101 communicates with main memory 122 via a system bus 150 (described in more detail below). FIG. 1C depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 101 communicates directly with cache memory 140 via a secondary bus, sometimes referred to as a backside bus. In other embodiments, the main processor 101 communicates with cache memory 140 using the system bus 150. Cache memory 140 typically has a faster response time than main memory 122 and is typically provided by SRAM, BSRAM, or EDRAM. In the embodiment shown in FIG. 1C, the processor 101 communicates with various I/O devices 130 via a local system bus 150. Various busses may be used to connect the central processing unit 101 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 101 may use an Advanced Graphics Port (AGP) to communicate with the display 124. FIG. 1D depicts an embodiment of a computer 100 in which the main processor 101 communicates directly with I/O device 130 via HyperTransport, Rapid I/O, or InfiniBand. FIG. 1D also depicts an embodiment in which local busses and direct communication are mixed: the processor 101 communicates with I/O device 130 using a local interconnect bus while communicating with I/O device 130 directly.

The computing device 100 may support any suitable installation device 116, such as a floppy disk drive for receiving floppy disks such as 3.5-inch, 5.25-inch disks or ZIP disks, a CD-ROM drive, a CD-R/RW drive, a DVD-ROM drive, tape drives of various formats, USB device, hard-drive or any other device suitable for installing software and programs such as any client agent 120, or portion thereof. The computing device 100 may further comprise a storage device 128, such as one or more hard disk drives or redundant arrays of independent disks, for storing an operating system and other related software, and for storing application software programs such as any program related to the client agent 120. Optionally, any of the installation devices 116 could also be used as the storage device 128. Additionally, the operating system and the software can be run from a bootable medium, for example, a bootable CD, such as KNOPPIX®, a bootable CD for GNU/Linux that is available as a GNU/Linux distribution from knoppix.net.

Furthermore, the computing device 100 may include a network interface 118 to interface to a Local Area Network (LAN), Wide Area Network (WAN) or the Internet through a variety of connections including, but not limited to, standard telephone lines, LAN or WAN links (e.g., 802.11, T1, T3, 56 kb, X.25), broadband connections (e.g., ISDN, Frame Relay, ATM), wireless connections, or some combination of any or all of the above. The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein. A wide variety of I/O devices 130a-130n may be present in the computing device 100. Input devices include keyboards, mice, trackpads, trackballs, microphones, and drawing tablets. Output devices include video displays, speakers, inkjet printers, laser printers, and dye-sublimation printers. The I/O devices 130 may be controlled by an I/O controller 123 as shown in FIG. 1C. The I/O controller may control one or more I/O devices such as a keyboard 126 and a pointing device 127, e.g., a mouse or optical pen. Furthermore, an I/O device may also provide storage 128 and/or an installation medium 116 for the computing device 100. In still other embodiments, the computing device 100 may provide USB connections to receive handheld USB storage devices such as the USB Flash Drive line of devices manufactured by Twintech Industry, Inc. of Los Alamitos, Calif.

In some embodiments, the computing device 100 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may comprise multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices, such as computing devices 100a and 100b connected to the computing device 100, for example, via a network. These embodiments may include any type of software designed and constructed to use another computer's display device as a second display device 124a for the computing device 100. One ordinarily skilled in the art will recognize and appreciate the various ways and embodiments that a computing device 100 may be configured to have multiple display devices 124a-124n.

In further embodiments, an I/O device 130 may be a bridge 170 between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 100 of the sort depicted in FIGS. 1C and 1D typically operate under the control of operating systems, which control scheduling of tasks and access to system resources. The computing device 100 can be running any operating system such as any of the versions of the Microsoft® Windows operating systems, the different releases of the Unix and Linux operating systems, any version of the Mac OS® for Macintosh computers, any embedded operating system, any real-time operating system, any open source operating system, any proprietary operating system, any operating systems for mobile computing devices, or any other operating system capable of running on the computing device and performing the operations described herein. Typical operating systems include: WINDOWS 3.x, WINDOWS 95, WINDOWS 98, WINDOWS 2000, WINDOWS NT 3.51, WINDOWS NT 4.0, WINDOWS CE, and WINDOWS XP, all of which are manufactured by Microsoft Corporation of Redmond, Wash.; MacOS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others.

In other embodiments, the computing device 100 may have different processors, operating systems, and input devices consistent with the device. For example, in one embodiment the computer 100 is a Treo 180, 270, 1060, 600 or 650 smart phone manufactured by Palm, Inc. In this embodiment, the Treo smart phone is operated under the control of the PalmOS operating system and includes a stylus input device as well as a five-way navigator device. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

### B. Systems and Methods for Isolating on Screen Textual Data

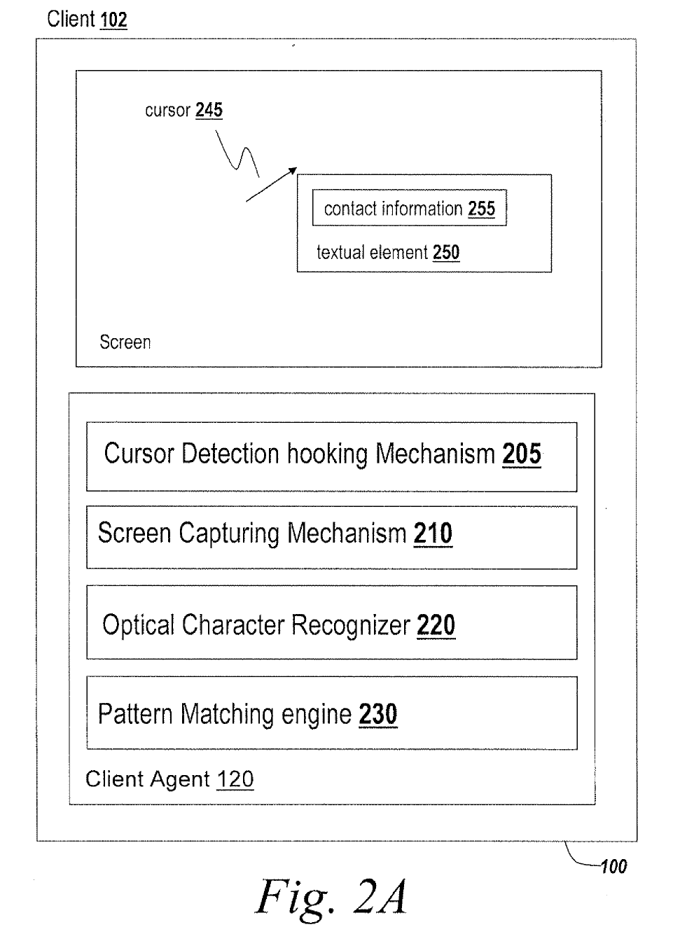

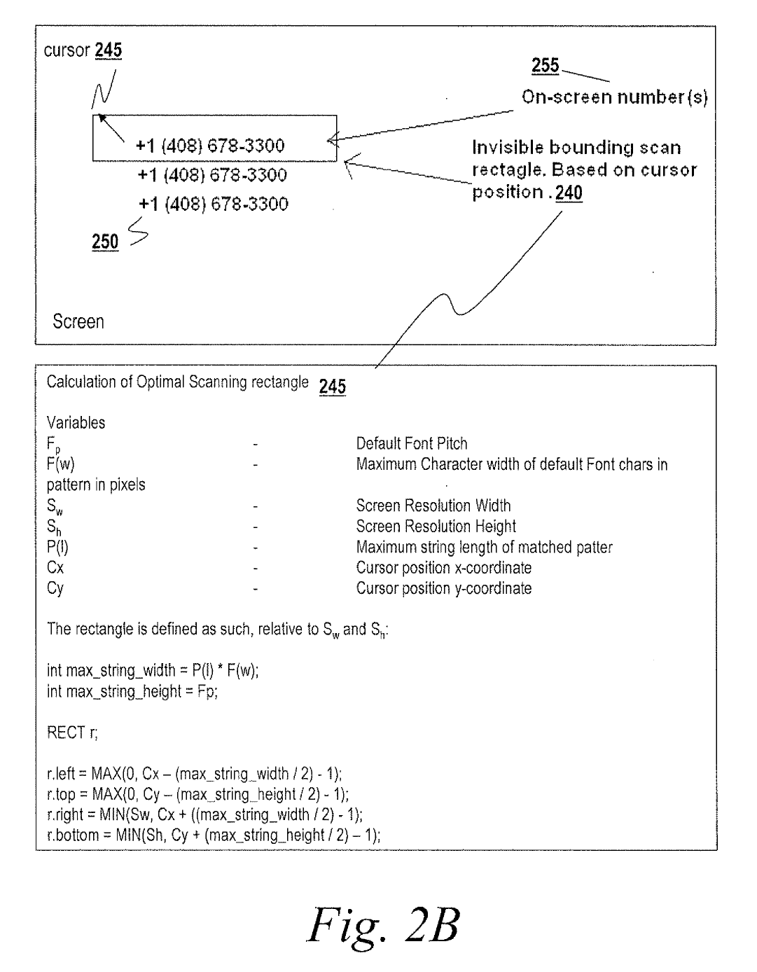

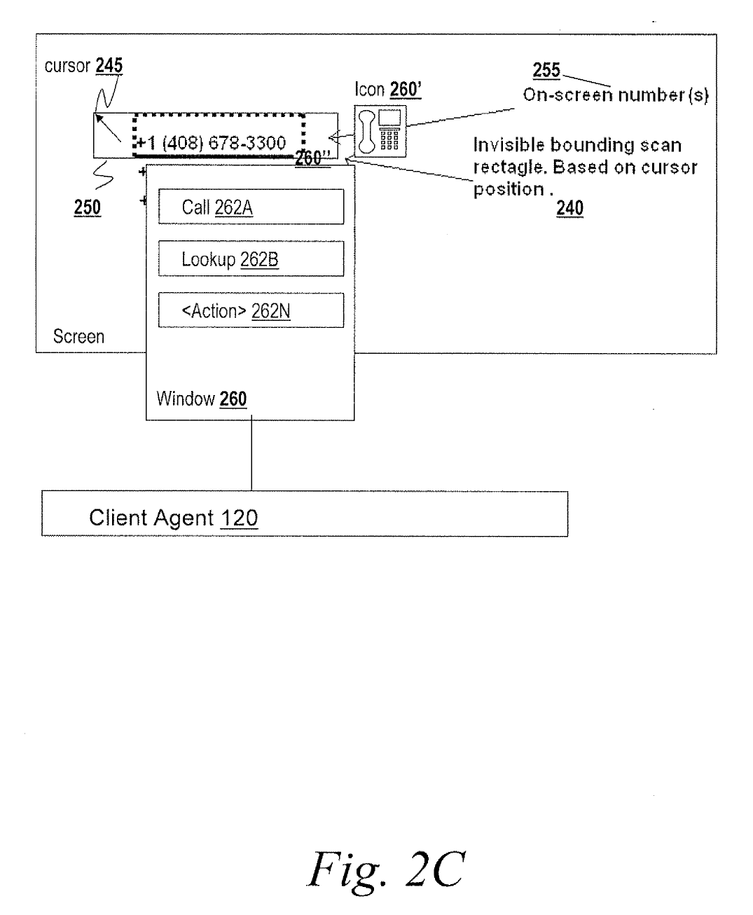

Referring now to FIG. 2A, an embodiment of a client agent 120 for isolating and acting upon on screen textual data in a non-intrusive and/or application agnostic manner is depicted. In brief overview, the client agent 120 includes a cursor detection hooking mechanism 205, a screen capturing mechanism 210, an optical character recognizer 220 and pattern matching engine 230. The client 102 may display a textual element 250 comprising contact information 255 on the screen accessed via a cursor 245. Via the cursor detection hooking mechanism 205, the client agent 120 detects the cursor 245 has been idle for a predetermined length of time, and in response to the detection, the client agent 120 via the screen capturing mechanism 210 captures a portion of the screen having the textual element 250 as an image. In one embodiment, a rectangular portion of the screen next to or near the cursor is captured The client agent 120 performs optical character recognition of the screen image via the optical character recognizer 220 to recognize any text of the textual element that may be included in the screen image. Using the pattern matching engine 230, the client agent 120 determines if the recognized text has any patterns of interest, such as a telephone number or other contact information 255.

Upon this determination, the client agent 120 can act upon the recognized text by providing a user interface element in the screen selectable by the user to take an action associated with the recognized text. For example, in one embodiment, the client agent 120 may recognize a telephone number in the screen captured text and provide a user interface element, such as an icon on window of menu options, for the user to select to initiate a telecommunication session such as via a IP Phone 175. That is, in one case, in response to recognizing a telephone number in the captured screen image of the textual information, the client agent 120 automatically provides an active user interface element comprising or linking to instructions that cause the initiation of a telecommunication session. In some cases, this may be referred to as a providing a “click-2-call” user interface element to the user.

The client 102 via the operating system, an application 185, or any process, program, service, task, thread, script or executable instructions may display on the screen, or off the screen (such as in the case of virtual or scrollable desktop screen), any type and form of textual element 250. A textual element 250 is any user interface element that may visually show text of one or more characters, such as any combination of letters, numbers or alpha-numeric or any other combination of characters visible as text on the screen. In one embodiment, the textual element 250 may be displayed as part of a graphical user interface. In another embodiment, the textual element 250 may be displayed as part of a command line or text-based interface. Although showing text, the textual element 250 may be implemented as an internal form, format or representation that is device dependent or application dependent. For example, an application may display text via an internal representation in the form of source code of a particular programming language, such as a control or widget implemented as an ActiveX Control or Java Script that displays text as part of its implementation. In some embodiments, although the pixels of the screen show textual data that is visually recognized by a human as text, the underlying program generating the display may not have the text in an electronic form that can be provided to or obtained by the client agent 120 via an interface to the program.

In further detail of FIG. 2A, the cursor detection mechanism 205 comprises any logic, function and/or operations to detect a status, movement or activity of a cursor, or pointing device, on the screen of the client 102. The cursor detection mechanism 205 may comprise software, hardware, or any combination of software and hardware. In some embodiments, the cursor detection mechanism 205 comprises an application, program, library, process, service, task, or thread. In one embodiment, the cursor detection mechanism 205 may include an application programming interface (API) hook into the operating system to obtain or gain access to events and information related to a cursor, and its movement on the screen. Using a API Hooking technique, the client agent 120 and/or cursor detection mechanism 205 monitors and intercepts operating system API calls related to the cursor and/or used by applications. In some embodiments, the cursor detection mechanism 205 API intercepts existing system or application's functions dynamically at runtime.

In another embodiment, the cursor detection mechanism 205 may include any type of hook, filter or source code for receiving cursor events or run-time information of the cursor's position on the screen, or any events generated by button clicks or other functions of the cursor. In other embodiments, the cursor detection mechanism 205 may comprise any type and form of pointing device driver, cursor driver, filter or any other API or set of executable instructions capable of receiving, intercepting or otherwise accessing events and information related to a cursor on the screen. In some embodiments, the cursor detection mechanism 205 detects the position of the cursor or pointing device on the screen, such as the cursor's x-coordinate and y-coordinate on the screen. In one embodiment, the cursor detection mechanism 205 detects, tracks or compares the movement of the cursor's X-coordinate and y-coordinate relative to a previous reported or received X and Y-coordinate position.

In one embodiment, the cursor detection mechanism 205 comprises logic, function and/or operations to detect if the cursor or pointing device is idle or has been idle for a predetermined or predefined length of time. In some embodiments, the cursor detection mechanism 205 detects the cursor has been idle for a predetermined length of time between 100 ms and 1 sec, such as 100 ms, 200 ms, 300 ms, 400 ms, 500 ms, 600 ms, 700 ms, 800 ms or 900 ms. In one embodiment, the cursor detection mechanism 205 detects the cursor has been idle for a predetermined length of time of approximately 500 ms, such as 490 ms, 495 ms, 500 ms, 505 ms or 510 ms. In some embodiments, the predetermined length of time to detect and consider the cursor is idle is set by the cursor detection mechanism 205. In other embodiments, the predetermined length of time is configurable by a user or an application via an API, graphical user interface or command line interface.

In some embodiments, a sensitivity of the cursor detection mechanism 205 may be set such that movements in either the X or Y coordinate position of the cursor may be received and the cursor still detected and/or considered idle. In one embodiment, the sensitivity may indicate the range of changes to either or both of the X and Y coordinates of the cursor which are allowed for the cursor to be considered idle by the cursor detection mechanism 205. For example, if the cursor has been idle for 200 ms and the user moves the cursor a couple or few pixels/coordinates in the X and/or Y direction, and then the cursor is idle for another 300 ms, the cursor detection mechanism 205 may indicate the cursor has been idle for approximately 500 ms.

The screen capturing mechanism 210, also referred to as a screen capturer, includes logic, function and/or operations to capture as an image any portion of the screen of the client 120. The screen capturing mechanism 210 may comprise software, hardware or any combination thereof In some embodiments, the screen capturing mechanism 210 captures and stores the image in memory. In other embodiments, the screen capturing mechanism 210 captures and stores the image to disk or file. In one embodiment, the screen capturing mechanism 210 includes or uses an application programming interface (API) to the operating system to capture an image of a screen or portion thereof. In some embodiments, the screen capturing mechanism 210 includes a library to perform a screen capture. In other embodiments, the screen capturing mechanism 210 comprises an application, program, process, service, task, or thread. The screen capturing mechanism 210 captures what is referred to as a screenshot, a screen dump, or screen capture, which is an image taken via the computing device 100 of the visible items on a portion or all of the screen displayed via a monitor or another visual output device. In one embodiment, this image may be taken by the host operating system or software running on the computing device. In other embodiments, the image may be captured by any type and form of device intercepting the video output of the computing device, such as output targeted to be displayed on a monitor.

The screen capturing mechanism 210 may capture and output a portion or all of the screen in any type of suitable format or device independent format, such as a bitmap, JPEG, GIF or Portable Network Graphics (PNG) format. In one embodiment, the screen capturing mechanism 210 may cause the operating system to dump the display into an internally used form as such as XWD X Window Dump image data in the case of X11 or PDF (portable document format) or PNG in the case of Mac OS X. In one embodiment, the screen capturing mechanism 210 captures an instance of the screen, or portion thereof, at one period of time. In yet another embodiment, the screen capturing mechanism 210 captures the screen, or portion thereof, over multiple instances. In one embodiment, the screen capturing mechanism 210 captures the screen, or portion thereof, over an extended period of time, such as to form a series of captures. In some embodiments, the screen capturing mechanism 210 is configured or is designed and constructed to include or exclude the cursor or mouse pointer, automatically crop out everything but the client area of the active window, take timed shots, and/or capture areas of the screen not visible on the monitor.

In some embodiments, the screen capturing mechanism 210 is designed and constructed, or otherwise configurable to capture a predetermined portion of the screen. In one embodiment, the screen capturing mechanism 210 captures a rectangular area calculated to be of a predetermined size or dimension based on the font used by the system. In some embodiments, the screen capturing mechanism 210 captures a portion of the screen relative to the position of the cursor 245 on the screen. For example, and as will be discussed in further detail below, FIG. 2B illustrates an example scanning area 240 used in one embodiment of the client agent 120. In this example, the client agent 120 screen captures a rectangular portion of the screen a scan area 240, based on screen resolution, screen font, and the cursor's X and Y coordinates.

Although the screen capturing mechanism 210 is generally described capturing a rectangular shape, any shape for the scanning area 240 may be used in performing the techniques and operations of the client agent 120 described herein. For the example, the scanning area 240 may be any type and form of polygon, or may be a circle or oval shape. Additionally, the location of the scanning area 240 may be any offset or have any distance relationship, far or near, to the position of the cursor 245. For example, the scanning area 240 or portion of the screen captured by the screen capturer 210 may be next to, under, or above, or any combination thereof with respect to the position of the cursor 245.

The size of the scanning area 240 of the screen capturing mechanism may be set such that any text of the textual element is obtained by the screen image while not making the scanning area 240 to large as to take an undesirable or unsuitable amount of processing time. The balance between the size of the scanning area 240 and the desired time for the client agent 120 to perform the operations described herein depends on the computing resources, power and capacity of the client device 100, the size and font of the screen, as well as the effects of resource consumption by the system and other applications.

Still referring to FIG. 2A, the client agent 120 includes or otherwise uses any type and form of optical character recognizer (OCR) 220 to perform character recognition on the screen capture from the screen capturing mechanism 210. The OCR 220 may include software, hardware or any combination of software and hardware. The OCR 220 may include an application, program, library, process, service, task or thread to perform optical character recognition on a screen captured in electronic or digitized form. Optical character recognition is designed to translate images of text, such as handwritten, typed or printed text, into machine-editable form, or to translate pictures of characters into an encoding scheme representing them, such as ASCII or Unicode.

In one embodiment, the screen capturing mechanism 210 captures the calculated scanning area 240 as an image and the optical character recognizer 220 performs OCR on the captured image. In another embodiment, the screen capturing mechanism 210 captures the entire screen or a portion of the screen larger than the scanning area 240 as an image, and the optical character recognizer 220 performs OCR on the calculated scanning area 240 of the image. In some embodiments, the optical character recognizer 220 is tuned to match any of the on-screen fonts used to display the textual element 250 on the screen. For example, in one embodiment, the optical character recognizer 220 determines the client's default fonts via an API call to the operating system or an application running on the client 102.

In other embodiments, the optical character recognizer 220 is designed to perform OCR in a discrete rather than continuous manner. Upon detection of the idle activity of the cursor, the client agent 120 captures a portion of the screen as an image, and the optical character recognizer 220 performs text recognition on that portion. The optical character recognizer 220 may not perform another OCR on an image until a second instance of idle cursor activity is detected, and a second portion of the screen is captured for OCR processing.

The optical character recognizer 220 may provide output of the OCR processing of the captured image of the screen in memory, such as an object or data structure, or to storage, such as a file output to disk. In some embodiments, the optical character recognizer 220 may provide strings of text via callback or event functions to the client agent 120 upon recognition of the text. In other embodiments, the client agent 120, or any portion thereof, such as the pattern matching engine 230, may obtain any text recognized by the optical character recognizer 220 via an API or function call.

As depicted in FIG. 2A, the client agent 120 includes or otherwise uses a pattern matching engine 230. The pattern matching engine 230 includes software, hardware, or any combination thereof having logic, functions or operations to perform matching of a pattern on any text. The pattern matching engine 220 may compare and/or match one or more records, such as one or more strings from a list of strings, with the recognized text provided by the optical character recognition 220. In one embodiment, the pattern matching engine 220 performs exact matching such as comparing a first string in a list of strings to the recognized text to determine if the strings are the same. In another embodiment, the pattern matching engine 220 performs approximate or inexact matching of a first string to a second string, such as the recognized text. In some embodiments, approximate or inexact matching includes comparing a first string to a second string to determine if one or more differences between the first string and the second string are with a predetermined or desired threshold. If the determined differences are less than or equal to the predetermined threshold, the strings may be considered to be approximately matched.

In one embodiment, the pattern matching engine 220 uses any decision trees or graph node techniques for performing an approximate match. In another embodiment, the pattern matching engine 230 may use any type and form of fuzzy logic. In yet another embodiment, the pattern matching engine 230 may use any string comparison functions or custom logic to perform matching and comparison. In still other embodiments, the pattern matching engine 230 performs a lookup or query in one or more databases to determine if the text can be recognized to be of a certain type or form. Any of the embodiments of the pattern matching engine 20 may also include implementation of boundaries and/or conditions to improve the performance or efficiency of the matching algorithm or string comparison functions.

In some embodiments, the pattern matching engine 230 performs a string or number comparison of the recognized text to determine if the text is in a form of a telephone, facsimile or mobile phone number. For example, the pattern matching engine 230 may determine if the recognized text in the form or has the format for a telephone number such as: ### ####, ###-####, (###) ###-####, ###-####-#### and the like, where # is a number or telephone number digit. As depicted in FIG. 2A, the client 102, such as via appliance 185, may display any type and form of contact information 255 on the screen as a textual element 250. The contact information 255 may include a person's name, street address, city/town, state, country, email address, telecommunication numbers (telephone, fax, mobile, Skype, etc), instant messaging contact info, a username for a system, a web-page or uniform resource locator (URL), and company information. As such, in other embodiments, the pattern matching engine 230 performs a comparison to determine if the recognized text is in the form of contact information 255, or portion thereof.

Although the pattern matching engine may generally be described with regards to telephone numbers or contact information 255, the pattern matching engine 230 may be configured, designed or constructed to determine if text has any type and form of pattern that may be of interest, such as a text matching any predefined or predetermined pattern. As such, the client agent 120 can be used to isolate any patterns in the recognized text and use any of the techniques described herein based on these predetermined patterns.

In some embodiments, the client agent 120, or any portions thereof, may be obtained, provided or downloaded, automatically or otherwise from the appliance 200. In one embodiment, the client agent 120 is automatically installed on the client 120. For example, the client agent 120 may be automatically installed when a user of the client 102 accesses the appliance 200, such as via a web-page, for example, a web-page to login to a network 104. In some embodiments, the client agent 120 is installed in silent-mode transparently to a user or application of the client 102. In another embodiment, the client agent 120 is installed such that it does not require a reboot or restart of the client 102.

Referring now to FIG. 2B, an example embodiment of the client agent 120 for performing optical character recognition on a screen capture image of a portion of the screen is depicted. In brief overview, the screen depicts a textual element 250 comprising contact information 255 in the form of telephone numbers. The cursor 245 is positioned or otherwise located near the top left corner of the textual element 250, or the first telephone number in the list of telephone numbers. For example, the cursor 245 may be currently idle at this position on the screen. The client agent 120 detects the cursor 245 may be idle for the predetermined length of time and captures and scans a scan area 240 based on the cursor's position. As depicted by way of example, the scan area 240 may be a rectangular shape. Also, as depicted in FIG. 2B, the rectangular scan area 240 may include a telephone number portion of the textual element 250 as displayed on the screen. The calculation 245 of the scan area 240 is based on one or more of the following types of information: 1) default font, 2) screen resolution and cursor 3) position.

In further details of the embodiment depicted in FIG. 2B, the calculation of the scan area 240 is based on one or more of the following variables:

| | |
|---|---|
| Fₚ | Default Font Pitch |
| F(w) | Maximum Character width of default Font chars |
| | in pattern in pixels |
| S_{w} | Screen Resolution Width |
| Sₕ | Screen Resolution Height |
| P(l) | Maximum string length of matched pattern |
| Cx | Cursor position x-coordinate |
| Cy | Cursor position y-coordinate |

In one embodiment, the client agent 120 may set the values of any of the above via API calls to the operating system or an application. For example, in the case of a Windows operating system, the client agent 120 can make a call to GetSystemMetrics( ) function to determine information on the screen resolution. In another example, the client agent 120 can use an API call to read the registry to obtain information on the default system fonts. In a further example, the client agent 120 makes a call to the function GetCursorPos( ) to obtain the current cursor X and Y coordinates. In some embodiments, any of the above variables may be configurable. A user may specify a variable value via a graphical user interface or command line interface of the client agent 120.

In one embodiment, the client agent 120, or any portion thereof, such as the screen capturing mechanism 210 or optical character recognizer 220, calculates a rectangle for the scanning area 240 relative to the screen resolution width and height of S_{w} and Sₕ:

int max_string_width=P(1)*F(w);

int max_string_height=Fp;

RECT r;

r.left=MAX(0, Cx−(max_string_width/2)−1);

r.top=MAX(0, Cy−(max_string height/2)−1);

r.right=MIN(Sw, Cx+((max_string width/2)−1);

r.bottom=MIN(Sh, Cy+(max_string height/2)−1);

In other embodiments, the client agent 120, or any portion thereof, may use any offset of either or both of the X and Y coordinates of the cursor position, variables Cx and Cy, respectively, in calculating the rectangle 240. For example, an offset may be applied to the cursor position to place the scanning area 240 to any position on the screen to the left, right, above and/or below, or any combination thereof, relative to a position of the cursor 245. Also, the client agent 120 may apply any factor or weight in determining the max_string_width and max_string_height variables in the above calculation 245. Although the corners of the scanning area 240 are generally calculated to be symmetrical, any of the left, top, right and bottom locations of the scanning area 240 may each be calculated to be at different locations relative to the max_string_width and max_string_height variables. In one embodiment, the client agent 120 may calculate the corners of the scanning area 240 to be set to a predetermined or fixed size, such as that it is not relative to the default font size.

Referring now to FIG. 2C, an embodiment of the client agent 120 providing a selectable user interface element associated with the recognized text of a textual element is depicted. In brief overview, the client agent 120 displays a selectable user interface element, such as a window 260, an icon 260′ or hyperlink 260″, in a manner that is not intrusive to an application but overlays or superimposes a portion of the screen area of the application displaying the textual element 250 having text recognized by the client agent 120. As shown by way of example, the client agent 120 recognizes as a telephone number a portion of the textual element 250 near the position of the cursor 245. In response to determining the recognized text matches a pattern for a telephone number, the client agent 120 displays a user interface element 260, 260′ selectable by a user to take an action related to the recognized text or textual element.

In further detail, the selectable user interface element 260 may include any type and form of user interface element. In some embodiments, the client agent 120 may display multiple types or forms of user interface elements 260 for a recognized text of a textual element 250 or for multiple instances of recognized text of textual elements. In one embodiment, the selectable user interface element includes an icon 260′ having any type of graphical design or appearance. In some embodiments, the icon 260′ has a graphical design related to the recognized text or such that a user recognizes the icon as related to the text or taking an action related to the text. For example and as shown in FIG. 2C, a graphical representation of a phone may be used to prompt the user to select the icon 260′ for initiating a telephone call. When selected, the client agent 120 initiates a telecommunication session to the telephone number recognized in the text of the textual element 250 (e.g., 1 (408) 678-3300).

In another embodiment, the selectable user interface element 260 includes a window 260 providing a menu of one or more actions or options to take with regards to the recognized text. For example, as shown in FIG. 2C, the client agent 120 may display a window 260 allowing the user to select one of multiple menu items 262A-262N. By way of example, a menu item 262A may allow the user to initiate a telecommunication session to the telephone number recognized in the text of the textual element 250 (e.g., 1 (408) 678-3300). The menu time 262B may allow the user to lookup other information related to the recognized text, such as contact information (e.g., name, address, email, etc.) of a person or a company having the telephone number (e.g., 1 (408) 678-3300).

The window 260′ may be populated with a menu item 262N to take any desired, suitable or predetermined action related to the recognized text of the textual element. For example, instead of calling the telephone number, the menu item 262N may allow the user to email the person associated with the telephone number. In another example, the menu item 262N may allow the user to store the recognized text into another application, such as creating a contact record in a contact management system, such as Microsoft Outlook manufactured by the Microsoft Corporation, or a customer relationship management system such salesforce.com provided by Salesforce.com, Inc. of San Francisco, Calif. In another example, the menu item 262N may allow the user to verify the recognized text via a database. In a further example, the menu item 262N may allow the user to give feedback or indication to the client agent if the recognized text is an invalid format, incorrect or otherwise does not correspond to the associated text.

In still another embodiment, the user interface element may include a graphical element to simulate, represent or appear as a hyperlink 260″. For example, as depicted in FIG. 2C, a graphical element may be in the form of a line appearing under the recognized text, such as to make the recognized text appear as a hyperlink. The user element 260′ may include a hot spot or transparent selectable background superimposed or overlaying the recognized text (e.g., telephone number 1 (408) 678-3300) as depicted by the dotted-lines around the recognized text. In this manner, a user may select either the underlined portion or the background portion of the hyperlink graphics to select the user interface element 260″.

Any of the types and forms of user interface element 260, 260′ or 260″ may be active or selectable to take a desired or predetermined action. In one embodiment, the user interface element 260 may comprise any type of logic, function or operation to take an action. In some embodiments, the user interface element 260 includes a Uniform Resource Locator. In other embodiments, the user interface element 260 includes an URL address to a web-page, directory, or file available on a network 104. In some embodiments, the user interface element 260 transmits a message, command or instruction. For example, the user interface element 260 may transmit or cause the client agent 120 to transmit a message to the appliance 200. In another embodiment, the user interface element 260 includes script, code or other executable instructions to make an API or function call, execute a program, script or application, or otherwise cause the computing device 100, an application 185 or any other system or device to take a desired action.

For example, in one embodiment, the user interface element 260 calls a TAPI 195 function to communicate with the IP Phone 175. The user interface element 260 is configured, designed or constructed to initiate or establish a telecommunication session via the IP Phone 175 to the telephone number identified in the recognized text of the textual element 250. In another embodiment, the user interface element 360 is configured, designed or constructed to transmit a message to the appliance 200, or have the client agent 120 transmit a message to the appliance 200, to initiate or establish a telecommunication session via the IP Phone 175 to the telephone number identified in the recognized text of the textual element 250. In yet another embodiment, in response to a message, call or transaction of the user interface element, the appliance 200 and client agent 120 work in conjunction to initiate or establish a telecommunication session.

As discussed herein, a telecommunication session includes any type and form of telecommunication using any type and form of protocol via any type and form of medium, wire-based, wireless or otherwise. By way of example a telecommunication may session includes but is not limited to a telephone, mobile, VoIP, soft phone, email, facsimile, pager, instant messaging/messenger, video, chat, short message service (SMS), web-page or blog communication, or any other form of electronic communication.

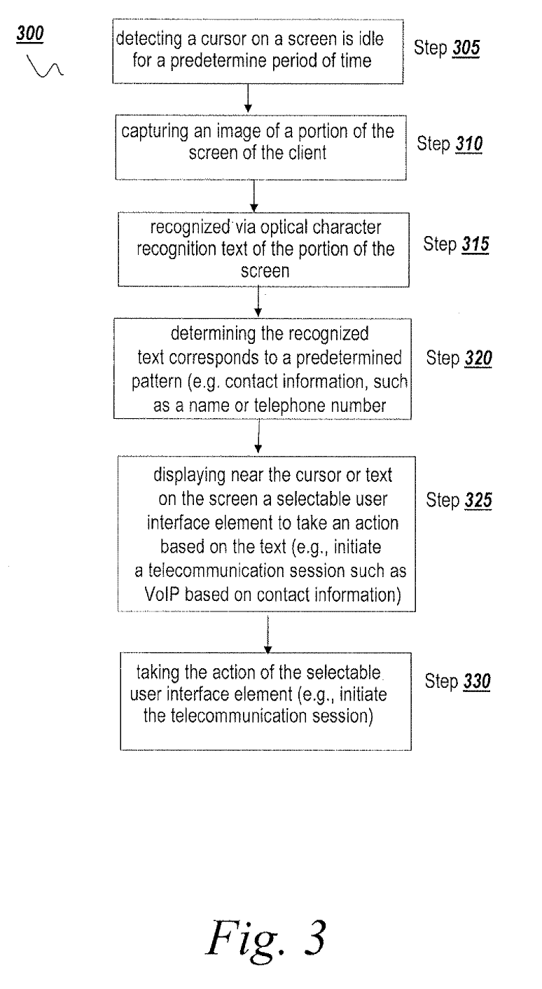

Referring now to FIG. 3, an embodiment of a method for practicing a technique of isolating text on a screen and taking an action related to the recognized text via a provided user interface element is depicted. In brief overview of method 300, at step 305, the client agent 120 detects a cursor on a screen is idle for a predetermined length of time. At step 310, the client agent 120 captures a portion of the screen of the client as an image. The portion of the screen may include At step 315, the client agent 120 recognizes via optical character recognition any text of the captured screen image. At step 320, the client agent 120 determines via pattern matching the recognized text corresponds to a predetermined pattern or text of interest. At step 325, the client agent 120 displays on the screen a selectable user interface element to take an action based on the recognized text. At step 330, the action of the user interface element is taken upon selection by the user.

In further detail, at step 305, the client agent 120 via the cursor detection mechanism 205 detects an activity of the cursor or pointing device of the client 102. In some embodiments, the cursor detection mechanism 205 intercepts, receives or hooks into events and information related to activity of the cursor, such as button clicks and location or movement of the cursor on the screen. In another embodiment, the cursor detection mechanism 205 filters activity of the cursor to determine if the cursor is idle or not idle for a predetermined length of time. In one embodiment, the cursor detection mechanism 205 detects the cursor has been idle for a predetermined amount of time, such as approximately 500 ms. In another embodiment, the cursor detection mechanism 205 detects the cursor has not been moved from a location for more than a predetermined length of time. In yet another embodiment, the cursor detection mechanism 205 detects the cursor has not moved from within a predetermined range or offset from a location on the screen for a predetermined length of time. For example, the cursor detection mechanism 205 may detect the cursor has remained within a predetermined number of pixels or coordinates from an X and Y coordinate for a predetermined length of time.

At step 310, the client agent 120 via the screen capturing mechanism 210 captures a screen image. In one embodiment, the screen capturing mechanism 210 captures a screen image in response to detection of the cursor being idle by the cursor detector mechanism 205. In other embodiments, the screen capturing mechanism 210 captures the screen image in response to a predetermined cursor activity, such as a mouse or button click, or movement from one location to another location. In one embodiment, the screen capturing mechanism 210 captures the screen image in response to the highlighting or selection of a textual element, or portion thereof on the screen. In some embodiments, the screen capturing mechanism 210 captures the screen image in response to a sequence of one or more keyboard selections, such as a control key sequence. In yet another embodiment, the client agent 120 may trigger the screen capturing mechanism 210 to take a screen capture on a predetermined frequency basis, such as every so many milliseconds or seconds.

In some embodiments, the screen capturing mechanism 210 captures an image of the entire screen. In other embodiments, the screen capturing mechanism 210 captures an image of a portion of the screen. In some embodiments, the screen capturing mechanism 210 calculated a predetermined scan area 240 comprising a portion of the screen. In one embodiment, the screen capturing mechanism 210 captures an image of a screening area 240 calculated based on default font, cursor position, and screen resolution information as discussed in conjunction with FIG. 2B. For example, the screen capturing mechanism 210 captures a rectangular area. In some embodiments, the screen capturing mechanism 210 captures an image of a portion of the screen relative to a position of the cursor. For example, the screen capturing mechanism 210 captures an image of the screen area next to or besides the cursor, or underneath or above the cursor. In one embodiment, the screen capturing mechanism 210 captures an image of a rectangular area 240 where the cursor position is located at one of the corners of the rectangle, such as the top left corner. In another embodiment, the screen capturing mechanism 210 captures an image of a rectangular area 240 relative to any offsets to either or both of the cursor's X and Y coordinate positions.

In some embodiments, the screen capturing mechanism 210 captures an image of the screen, or portion thereof, in any type of format, such as a bitmap image. In another embodiment, the screen capturing mechanism 210 captures an image of the screen, or portion thereof, in memory, such as in a data structure or object. In other embodiments, the screen capturing mechanism 210 captures an image of the screen, or portion thereof, into storage, such as in a file.

At step 315, the client agent 120 via the optical character recognizer 220 performs optical character recognition on the screen image captured by the screen capturing mechanism 310. In some embodiments, the optical character recognizer 220 performs an OCR scan on the entire captured image. In other embodiments, the optical character recognizer 220 performs an OCR scan on a portion of the captured image. For example, in one embodiment, the screen capturing mechanism 210 captures an image of the screen larger than the calculated scan area 240, and the optical character recognizer 220 performs recognition on the calculated scan area 240.

In one embodiment, the optical character recognizer 220 provides the client agent 120, or any portion thereof, such as the pattern matching engine 230, any recognized text as it is recognized or upon completion of the recognition process. In some embodiments, the optical character recognizer 220 provides the recognized text in memory, such as via an object or data structure. In other embodiments, the optical character recognizer 220 provides the recognized text in storage, such as in a file. In some embodiments, the client agent 120 obtains the recognized text from the optical character recognizer 220 via an API function call, or an event or callback function.

At step 320, the client agent 120 determines if any of the text recognized by the optical character recognizer 220 is of interest to the client agent 120. The pattern matching engine 230 may perform exact matching, inexact matching, string comparison or any other type of format and content comparison logic to determine if the recognized text corresponds to a predetermined or desired pattern. In one embodiment, the pattern matching engine 230 determined if the recognized text has a format corresponding to a predetermined pattern, such as a pattern of characters, numbers or symbols. In some embodiments, the pattern matching engine 230 determines if the recognized text corresponds to or matches any predetermined or desired patterns. In one embodiment, the pattern matching engine 230 determines if the recognized text corresponds to a format of any portion of a contact information 255, such as a phone number, fax number, or email address. In some embodiments, the pattern matching engine 230 determines if the recognized text corresponds to a name or identifier of a person, or a name or an identifier of a company. In other embodiments, the pattern matching engine 230 determines if the recognized text corresponds to an item of interest or a pattern queried in a database or file.

At step 325, the client agent 120 displays a user interface element 260 near or in the vicinity of the recognized text or textual element 25 that is selectable by a user to take an action based on, related to or corresponding to the text. In one embodiment, the client agent 120 displays the user interface element in response to the pattern matching engine 230 determining the recognized text corresponds to a predetermined pattern or pattern of interest. In some embodiments, the client agent 120 displays the user interface element in response to the completion of the pattern matching by the pattern matching engine 230 regardless if something of interest is found or not. In other embodiments, the client agent 120 displays the user interface element in response to the recognition of the optical character recognizer 220 recognizing text. In one embodiment, the client agent 120 displays the user interface element in response to a mouse or pointer device click, or combination of clicks. In another embodiment, the client agent 120 displays the user interface element in response to a keyboard key selections or sequence of selections, such as a control or alt key sequence of key strokes.

In some embodiments, the client agent 120 displays the user interface element superimposed over the textual element 250, or a portion thereof. In other embodiments, the client agent 120 displays the user interface element next to, besides, underneath or above the textual element 250, or a portion thereof. In one embodiment, the client agent 120 displays the user interface element as an overlay to the textual element 250. In some embodiments, the client agent 120 displays the user interface element next to or in the vicinity of the cursor 245. In yet another embodiment, the client agent 120 displays the user interface element in conjunction with the position or state of cursor 245, such as when the cursor 245 is idle or is idle near or on the textual element 250.

In some embodiments, the client agent 120 creates, generates, constructs, assembles, configures, defines or otherwise provides a user interface element that performs or causes to perform an action related to, associated with or corresponding to the recognized text. In one embodiment, the client agent 120 provides a URL for the user interface element. In some embodiments, the client agent 120 includes a hyperlink in the user interface element. IN other embodiments, the client agent 120 includes a command in a markup language, such as Hypertext Transfer Protocol (HTTP), or Extensible Markup Language (XML) in the user interface element, In another embodiment, the client agent 120 includes a script for the user interface element. In some embodiments, the client agent 120 includes executable instructions, such as an API call or function call for the user interface element. For example, in one case, the client agent 120 includes an ActiveX control or Java Script, or a link thereto, in the user interface element. In one embodiment, the client agent 120 provides a user interface element having an AJAX script (Asynchronous JavaScript and XML). In some embodiments, the client agent 120 provides a user interface element that interfaces to, calls an interface of, or otherwise communicates with the client agent 120.

In a further embodiment, the client agent 120 provides a user interface element that transmits a message to the appliance 200. In some embodiment, the client agent 120 provides a user interface element that makes a TAPI 195 API call. In other embodiments, the client agent 120 provides a user interface element that sends a Session Initiation Protocol (SIP) message. In some embodiments, the client agent 120 provides a user interface element that sends a SMS message, email message, or an Instant Messenger message. In yet another embodiment, the client agent 120 provides a user interface element that establishes a session with the appliance 200, such as a Secure Socket Layer (SSL) session via a virtual private network connection to a network 104.

In one embodiment, the client agent 120 recognizes the text as corresponding to a pattern of a phone number, and displays a user interface element selectable to initiate a telecommunication session using the phone number. In another embodiment, the client agent 120 recognizes the text as corresponding to a portion of contact information 255, and performs a lookup in a directory server such as LDAP to determine a phone number or email address of the contact. For example, the client agent 120 may lookup or determine the hone number for a company or entity name recognized in the text. The client agent 120 then may display a user interface element to initiate a telecommunication session using the contact information looked up based on the recognized text. In one embodiment, the client agent 120 recognizes the text as corresponding to a phone number and displays a user interface element to initiate a VoIP communication session.

In some embodiments, the client agent 120 recognizes the text as corresponding to a pattern of an email and displays a user interface element selectable to initiate an email session. In other embodiments, the client agent 120 recognizes the text as corresponding to a pattern of an instant messenger (IM) identifier and displays a user interface element selectable to initiate an IM session. In yet another embodiment, the client agent 120 recognizes the text as corresponding to a pattern of a fax number and displays a user interface element selectable to initiate a fax to the fax number.

At step 330, a user selects the selectable user interface element displayed via the client agent 120 and the action provided by the user interface element is performed. The action taken depends on the user interface element provided by the client agent 120. In some embodiments, upon selection of the user interface element, the user interface element or the client agent 120 takes an action to query or lookup information related to the recognized text in a database or system. In other embodiments, upon selection of the user interface element, the user interface element or client agent 120 takes an action to save information related to the recognized text in a database or system. In yet another embodiment, upon selection of the user interface element, the user interface element or client agent 120 takes an action to interface, make an API or function call to an application, program, library, script services, process or task. In a further embodiment, upon selection of the user interface element, the user interface element or client agent 120 takes an action to execute a script, program or application.

In one embodiment, upon selection of the user interface element, the client agent 120 initiates and establishes a telecommunication session for the user based on the recognized text. In another embodiment, upon selection of the user interface element, the client 102 initiates and establishes a telecommunication session for the user based on the recognized text. In one example, the client agent 120 makes a TAPI 195 API call to the IP Phone 175 to initiate the telecommunication session. In some cases, the user interface element or the client agent 120 may transmit a message to the appliance to initiate or establish the telecommunication session. In one embodiment, upon selection of the user interface element, the appliance 200 initiates and establishes a telecommunication session for the user based on the recognized text. For example, the appliance 200 may query IP Phone related calling information from an LDAP directory and request the client agent 120 to establish the telecommunication session with the IP phone 175, such as via TAPI 195 interface. In another embodiment, the appliance 200 may interface or communicate with the IP Phone 175 to initiate and/or establish the telecommunication session, such as via TAPI 195 interface. In yet another embodiment, the appliance 200 may communicate, interface or instruct the call server 185 to initiate and/or establish a telecommunication session with an IP Phone 15A-175N.

In some embodiments, the client agent 120 is configured, designed or constructed to perform steps 305 through 325 of method 300 in 1 second or less. In other embodiments, the client agent 120 performs steps 310 through step 330 in 1 second or less. In some embodiments, the client agent 120 performs steps 310 through 330 in 500 ms, 600 ms, 700 ms, 800 ms or 900 ms, or less. In one case, since the client agent 120 performs scanning and optical character recognition on a portion of the screen, such as the scanning area 240, the client agent 120 can perform steps of the method 300 in a timely manner, such as in 1 second or less. In another embodiment, since the scanning area 240 is optimized based on the cursor position, default font and screen resolution, the client agent 120 can screen capture and perform optical recognition in a manner that enables the steps of the method 300 to be performed in a timely manner, such as in 1 second or less.

Using the techniques described herein, the client agent 120 provides a technique of obtaining text displayed on the screen non-intrusively to any application of the client. In one embodiment, by the client agent 120 performing the steps of method 300 in a timely manner, the client agent 120 performs its text isolation technique non-intrusively to any of the applications that may be displaying textual elements on the screen. In another embodiment, by performing any of the steps of method 300 in response to detecting the cursor is idle, the client agent 120 performs its text isolation technique non-intrusively to any of the applications that may be displaying textual elements on the screen. Additionally, by performing screen capture of the image to obtain text from the textual element instead of interfacing with the application, for example, via an API, the client agent 120 performs its text isolation technique non-intrusively to any of the applications executing on the client 102.

The client agent 120 also performs the techniques described herein agnostic to any application. The client agent 120 can perform the text isolation technique on text displayed on the screen by any type and form of application 185. Since the client agent 120 uses a screen capture technique that does not interface directly with an application, the client agent 120 obtains text from textual elements as displayed on the screen instead of from the application itself. As such, in some embodiment, the client agent 120 is unaware of the application displaying a textual element. In other embodiments, the client agent 120 learns of the application displaying the textual element only from the content of the recognized text of the textual element.

By displaying a user interface element, such as a window or icon, as an overlay or superimposed on the screen, the client agent 120 provides an integration of the techniques and features described herein in a manner that is seamless or transparent to the user or application of the client, and also non-intrusively to the application. In one embodiment, the client agent 120 executes on the client 120 transparently to a user or application of the client 102. In some embodiments, the client agent 120 may display the user interface element in such a way that it appears to the user that the user interface element is a part of or otherwise displayed by an application on the client.

In view of the structure, functions and operations of the described herein, the client agent provides for techniques to isolate text of on-screen textual data in a manner non-intrusive and agnostic to any application of the client. Based on recognizing the isolated text, the client agent 120 enables a wide variety of applications and functionality to be integrated in a seamless way by displayed a configurable selectable user interface element associated with the recognized text. In one example deployment of this technique, the client agent 120 automatically recognizes contact information of on-screen textual data, such as a phone number, and displays a user interface element that can be clicked to initiate a telecommunication session, a phone call, referred to as “click-2-call” functionality.

Many alterations and modifications may be made by those having ordinary skill in the art without departing from the spirit and scope of the invention. Therefore, it must be expressly understood that the illustrated embodiments have been shown only for the purposes of example and should not be taken as limiting the invention, which is defined by the following claims. These claims are to be read as including what they set forth literally and also those equivalent elements which are insubstantially different, even though not identical in other respects to what is shown and described in the above illustrations.

We claim:

1. A method of determining a user interface is displaying a textual element identifying contact information and automatically providing in response to the determination a selectable user interface element near the textual element to initiate a telecommunication session based on the contact information, the method comprising the steps of:
(a) capturing, by a client agent, an image of a portion of a screen of a client, the portion of the screen displaying a textual element identifying contact information;
(b) recognizing, by the client agent, via optical character recognition text of the textual element in the captured image;
(c) determining, by the client agent, the recognized text comprises contact information; and
(d) displaying, by the client agent in response to the determination, a user interface element near the textual element on the screen selectable to initiate a telecommunication session based on the contact information.

2. The method of claim 1, wherein step (a) comprises capturing, by the client agent, the image in response to detecting the cursor on the screen is idle for a predetermined length of time.

3. The method of claim 2, wherein the predetermined length of time is between 400 ms and 600 ms.

4. The method of claim 1, wherein step (d) comprises displaying, by the client agent, a window near one of the cursor or textual element on the screen, the window providing the selectable user interface element to initiate the telecommunication session.

5. The method of claim 1, comprising displaying, by the client agent, the selectable user interface element superimposed over the portion of the screen.

6. The method of claim 1, comprising displaying, by the client agent, the user interface element as a selectable icon.

7. The method of claim 1, comprising displaying, by the client agent, the selectable user interface element while the cursor is idle.

8. The method of claim 1, wherein step (a) comprises capturing, by the client agent, the image of the portion of the screen as a bitmap.

9. The method of claim 1, comprising identifying, by the contact information, one of a name of a person, a name of a company, or a telephone number.

10. The method of claim 1, comprising selecting, by a user of the client, the selectable user interface element to initiate the telecommunication session.

11. The method of claim 10, comprising transmitting, by the client agent, information to a gateway device to establish the telecommunication session on behalf of the client.

12. The method of claim 11, comprising establishing, by the gateway device, the telecommunications session via a telephony application programming interface.

13. The method of claim 10, comprising establishing, by the client agent, the telecommunications session via a telephony application programming interface.

14. The method of claim 1, wherein step (c) comprising performing, by the client agent, pattern matching on the recognized text.

15. The method of claim 1, comprising performing, by the client agent, step (a) through step (d) in a period of time not exceeding 1 second.

16. The method of claim 1, comprising identifying, by the client agent, the portion of the screen as a rectangle determined based on one or more of the following: default font pitch, screen resolution width, screen resolution height, x-coordinate of the position of the cursor and y-coordinate of the position of the cursor.

17. The method of claim 1, wherein step (a) comprises capturing, by the client agent, the image of the portion of the screen relative to a position of a cursor.

18. A system for determining a user interface is displaying a textual element identifying contact information and automatically providing in response to the determination a selectable user interface element near the textual element to initiate a telecommunication session based on the contact information, the system comprising:
a client agent executing on a client, the client agent comprising a cursor activity detector to detect activity of a cursor on a screen;
a screen capture mechanism capturing, in response to the cursor activity detector, an image of a portion of the screen displaying a textual element identifying contact information;
an optical character recognizer recognizing text of the textual element in the captured image;
a pattern matching engine determining the recognized text comprises contact information; and
wherein the client agent displays in response to the determination a user interface element near the textual element on the screen selectable to initiate a telecommunication session based on the contact information.

19. The system of claim 18, wherein the screen capture mechanism captures the image in response to detecting the cursor on the screen is idle for a predetermined length of time.

20. The system of claim 19, wherein the predetermined length of time is between 400 ms and 600 ms.

21. The system of claim 18, wherein the client agent displays a window near one of the cursor or textual element on the screen, the window providing the selectable user interface element to initiate the telecommunication session.

22. The system of claim 18, wherein the client agent displays the selectable user interface element superimposed over the portion of the screen.

23. The system of claim 18, wherein the client agent displays the user interface element as a selectable icon.

24. The system of claim 18, wherein the client agent displays the selectable user interface element while the cursor is idle.

25. The system of claim 18, wherein the screen capturing mechanism captures the image of the portion of the screen as a bitmap.

26. The system of claim 18, wherein the contact information comprises one of a name of a person, a name of a company or a telephone number.

27. The system of claim 18, wherein a user of the client selects the selectable user interface element to initiate the telecommunication session.

28. The system of claim 27, wherein the client agent transmits information to a gateway device to establish the telecommunication session on behalf of the client.

29. The system of claim 28, wherein the gateway device establishes the telecommunications session via a telephony application programming interface.

30. The system of claim 27, wherein the client agent establishes the telecommunications session via a telephony application programming interface.

31. The system of claim 18, wherein the client agent identifies the portion of the screen as a rectangle determined based on one or more of the following: default font pitch, screen resolution width, screen resolution height, x-coordinate of the position of the cursor and y-coordinate of the position of the cursor.

32. The system of claim 18, wherein the screen capturing mechanism captures the image of the portion of the screen relative to a position of a cursor.

33. A method of automatically recognizing text of a textual element displayed by an application on a screen of a client and in response to the recognition displaying a selectable user interface element to take an action based on the text, the method comprising:
(a) detecting, by a client agent, a cursor on a screen of a client is idle for a predetermined length of time;
(b) capturing, by the client agent in response to the detection, an image of a portion of a screen of a client, the portion of the screen displaying a textual element;
(c) recognizing, by the client agent, via optical character recognition text of the textual element in the captured image;
(d) determining, by the client agent, the recognized text corresponds to a predetermined pattern; and
(e) displaying, by the client agent, near the textual element on the screen a selectable user interface element to take an action based on the recognized text in response to the determination.

34. The method of claim 33, wherein the predetermined length of time is between 400 ms and 600 ms.

35. The method of claim 33, wherein step (e) comprises displaying, by the client agent, a window near one of the cursor or textual element on the screen, the window providing the selectable user interface element to initiate the telecommunication session.

36. The method of claim 33, comprising displaying, by the client agent, the selectable user interface element superimposed over the portion of the screen.

37. The method of claim 33, comprising displaying, by the client agent, the user interface element as a selectable icon.

38. The method of claim 33, comprising displaying, by the client agent, the selectable user interface element while the cursor is idle.

39. The method of claim 33, wherein step (b) comprises capturing, by the client agent, the image of the portion of the screen as a bitmap.

40. The method of claim 33, wherein step (d) comprises determining, by the recognized text corresponds to a predetermined pattern of one of a name of a person, a name of a company or a telephone number.

41. The method of claim 33, comprising selecting, by a user of the client, the selectable user interface element to take the action based on the recognized text.

42. The method of claim 33, wherein the action comprise one of initiating a telecommunication session or querying contacting information based on the recognized text.

43. The method of claim 33, comprising identifying, by the client agent, the portion of the screen as a rectangle determined based on one or more of the following: default font pitch, screen resolution width, screen resolution height, x-coordinate of the position of the cursor and y-coordinate of the position of the cursor.

44. The method of claim 33, wherein step (b) comprises capturing, by the client agent, the image of the portion of the screen relative to a position of a cursor.
